(19) United States
(12) Patent Application Publication
(10) Pub. No.: US 2026/0120982 A1
(43) Pub. Date: Apr. 30, 2026

(54) FAST EARTHING SWITCH

(71) Applicant: Hitachi Energy Ltd, Zürich (CH)

(72) Inventors: David Saxl, Zürich (CH); Andrin Hinder, Holderbank AG (CH); Jonas Wegmann, Seuzach (CH)

(21) Appl. No.: 19/162,886

(22) PCT Filed: Mar. 7, 2023
(86) PCT No.: PCT/EP2023/055814

§ 371 Date: Sep. 5, 2025

(51) Int. Cl. H01H 31/00; H01H 31/02

(52) U.S. Cl. CPC H01H 31/003; H01H 31/026

(57) ABSTRACT

The invention relates to a fast earthing switch including two contact members of which at least one contact member is movable along an actuation direction in relation to the other contact member between a closed position, in which the contact members are electrically connected, and an open position, in which the contact members are electrically unconnected, the contact members defining an arcing region in which an arc is generated during a current interrupting operation and in which an arc-quenching medium is present; and an insulating member that is electrically insulating; wherein the movable contact member includes a first channel that at least sectionally extends along the actuation direction, the insulating member includes a second channel that at least sectionally extends along the actuation direction, the insulating member and the movable contact member are coupled to each other and the channels are in fluid communication to direct the arc-quenching medium.

### CROSS REFERENCE TO RELATED APPLICATIONS

This application is a 35 U.S.C. § 371 national stage application of International Application No. PCT/EP2023/055814 filed on Mar. 7, 2023, the disclosures and content of which are incorporated by reference herein in their entirety.

### TECHNICAL FIELD

The disclosure relates to a fast earthing switch comprising two contact members of which at least one contact member is movable along an actuation direction in relation to the other contact member between a closed position, in which the contact members are electrically connected, and an open position, in which the contact members are electrically unconnected, said contact members defining an arcing region in which an arc is generated during a current interrupting operation and in which an arc-quenching medium is present, wherein the movable contact member comprises a first channel that.

### BACKGROUND ART

A disconnector or earthing switch, also known as a grounding switch, is a protective device included in switchgear components like circuit breakers and isolators. When circuit breakers are removed and racked out, earthing switches automatically ground a part of a bus bar adjacent to the circuit breakers. For isolators, the earthing switches make contact with the bus bar when the isolator isolates the circuits, discharging any charges that may have gathered there. For example, an earthing switch in switchgear is used to ground a remaining change in a power line after the power line has been removed from its source. A residual charge often remains in a circuit after it has been severed or opened by the circuit breaker and isolator. An earthing switch is usually provided to discharge the charge.

Dielectric insulation media in liquid or gaseous state are conventionally applied for the insulation of an electrically conductive part in a wide variety of apparatuses, and in particular also in GIS or components thereof. In medium or high voltage metal-encapsulated switchgears, for example, the electrically conductive part is arranged in a gas-tight housing, which defines an insulating space, said insulation space comprising an insulation gas and separating the housing from the electrically conductive part without allowing electrical currents to pass through the insulation space.

For interrupting the current in e.g. high voltage switchgears, the insulating medium further functions as an arc-quenching medium or arc-extinction medium. This is for example also the case in a disconnector or in an earthing switch, in which the arc generated during current interruption is extinguished under free-burning conditions, meaning that the arc-quenching medium is not actively blown towards the arc.

In conventional gas-insulated switchgears, sulphur hexa-fluoride (SF6) is typically used as insulation medium and/or arc-quenching medium, respectively. Recently, the use of organofluorine compounds in an insulation medium has been suggested as a substitute for conventional insulation media, such as for example a fluoroketone having high insulation capabilities, in particular a high dielectric strength, as well as high arc extinction capabilities. At the same time, they have a very low Global Warming Potential (GWP) and very low toxicity.

A fast earthing switch, particularly a fast acting earthing switch, is typically operated by an operating mechanism that provides acceleration of the movable contact member and also its deacceleration. For a SF6 free solution of such fast earthing switch an arc-blowing mechanism can be used. In principle, required mass flow could be determined which would lead to some kind of pump mechanism. A piston of the arc-blowing mechanism to create the mass flow to the arc would require linear moving mass and therefore would add kinetic energy, which in turn would require high-performance damping devices with a strong power kinematic chain, resulting in increased costs and technical risks of mechanical lifetime.

The contact members have to conduct high electrical currents. Therefore, it is essential to use good conducting materials, such as copper, tungsten, gold, or a combination thereof (e.g. an alloy and/or a coating on an alloy) for at least one of the contact members.

The movable contact member is typically accelerated and deaccelerated quickly and/or at high acceleration rates which results in high forces to the materials from inertia. Especially since the movable contact member typically at least essentially comprises or consists of copper, tungsten, gold or an alloy therewith, it is observed that the inertia is higher relative to other electrically conductive materials like steel, aluminum, or others with lower density relative to copper/tungsten.

It is a target to provide the arc-quenching medium and/or arc-extinguishing gas preferably at a low temperature to the arcing region, but is also a target to keep the inertia low to achieve high acceleration rates (i.e. the absolute value of derivation of the speed, e.g. given in meters per square second) without mechanical failure.

After all, the choice of constructive parameters such as weight, size, cross section and/or composition of the movable contact member has a great impact on the performance of the fast earthing switch, where especially using more weight at the movable contact member in order to have a lower electrical resistance to interrupt larger currents, a duration for the switch to actually interrupt may increase from the increased inertia. Further, the movable contact member may be damaged from inertia.

### SUMMARY

It is therefore an object of the disclosure to provide an improved fast earthing switch for interrupting non-short-circuit currents. Particularly disadvantages of known solutions are to be avoided.

The object of the disclosure is solved by the features of the independent claims. Preferred implementations are detailed in the dependent claims.

Thus, the object is solved by a fast earthing switch in particular for interrupting non-short-circuit currents and/or for guiding short circuit currents to ground comprising two contact members of which at least one contact member is movable along an actuation direction in relation to the other contact member between a closed position, in which the contact members are electrically connected, and an open position, in which the contact members are electrically unconnected, said contact members defining an arcing region in which an arc is generated during a current interrupting operation and in which an arc-quenching medium is present; and an insulating member that is electrically insulating. It is particularly suggested that the movable contact member comprises a first channel that at least sectionally extends along the actuation direction, that the insulating member comprises a second channel that at least sectionally extends along the actuation direction, that the insulating member and the movable contact member are coupled to each other, and particularly that the channels are in fluid communication in order to direct the arc-quenching medium.

In other words a fast earthing switch is suggested that has two contact members which can be moved relative to each other in order to establish and/or disconnect an electrical contact between each other for a technical purpose, such as interrupting non-short-circuit currents or guiding short circuit currents to ground or others. The movable contact (member) has a channel and/or a passage. There is also an insulating member having another channel/passage and being mechanically connected to the movable contact member, thereby forming a continuous channel through both of said members in order to direct medium and/or gas along the direction of movement of the movable contact member. The movable contact member and/or the insulating member may comprise a tube-like shape. The channels are connected preferably at least essentially in a fluid tight manner. At least one of the channels may have a cylindrical shape and/or essentially define an axis of rotational symmetry of the corresponding member, the rotational symmetry preferably being considered in an at least essential manner, allowing for small deviations from full rotational symmetry (e.g. in order to couple a lever thereto, e.g. via a protrusion oblique to said axis). The insulating member can be moved together with the movable contact member when changing between the open position and the closed position.

Now that the movable contact member is coupled to the insulating member, it is the result that the inertia of the movable parts of the fast earthing switch is beneficially affected. The mass to be accelerated in the fast earthing switch can be reduced, since the insulating member is designed essentially disrespecting a transmission of electrical currents since it cannot transmit those, and at least essentially respecting the transmission of mechanical loads and providing the channel for the arc-quenching medium. Thus, more lightweight material can be adopted particularly for the insulating member, such as a composition comprising polymer, plastics, ceramics and/or another insulated or insulating material.

In addition, it is beneficial that the path of the electrical current is thus uncoupled from the path of the arc-quenching medium, so that the source of the arc-quenching medium can be designed with an increased freedom since no currents can be expected to flow along both of the channels, merely along the first channel.

The contact members can conduct electricity, where preferably at least one, two or all of the contact members and/or their parts comprise or at least substantially consist of a metal. One contact member may be held fixedly, e.g. relative to and/or in a housing, and the movable contact member may be movable along the actuation direction, e.g. relative to and/or in the housing. At least one contact member and/or the movable contact member, preferably the first channel, may be formed along and/or may follow the course of the actuation direction. The actuation direction, the first channel and/or the second channel is/are at least essentially, preferably partially or fully, straight. Thus, inertia can be reduced, among other advantages as named in the present application.

The fast earthing switch preferably has an arc-blowing mechanism. The arc-blowing mechanism may force the arc-quenching medium through a channel, preferably through the channels of the contact member and/or the insulating member. Further, an operating mechanism may be provided. The operating mechanism may be designed to accelerate the movable contact member and/or the insulating member when moving between the open position and the closed position. The arc-blowing mechanism and the operating mechanism are preferably mechanically connected so that the operating mechanism serves to operate the arc-blowing mechanism and to at least move the movable contact member. The arc-blowing mechanism may be mechanically connected to the insulating member and/or the contact member, particularly directly connected to the insulating member or formed therewith. The arc-blowing mechanism and the operating mechanism are described with various optional features and aspects that are each individually or in combination preferred as follows.

It can be an option that the fast earthing switch, particularly the arc-blowing mechanism, has a guiding tube, e.g. cylinder-like or with the shape of a cylinder, preferably in which the movable contact member, the insulating member, and/or a further member form(s) or is/are connected to a piston that is slidably arranged for linearly moving between the closed position and the open position particularly along the actuation direction. It is most preferred that the insulating member is on one side/end coupled to the movable contact member (e.g. a coupling part thereof) and on the opposite side/end forms or is connected to the piston. The guiding tube may be closed at an upper end and/or at a thereto opposite lower end so that that the piston defines a first compression chamber with the upper end and/or a second compression chamber with the lower end for thereby decelerating movement of the piston when moving into the open position and/or into the closed position.

The described option performs the deacceleration by means of a gas damper provided by the piston and the guiding tube respectively the upper end and/or the lower end of the guiding tube, thereby resulting in reduced wear and reduced high mechanical loads, e.g. on the operating mechanism that is typically maximum loaded, and especially when deacceleration takes place. In other words, the piston the required for creating a mass flow to the arc is a used in its end positions as gas damper thereby allowing a deacceleration at both ends of the stroke. Further, as the kinetic energy to be absorbed in a close operation i.e. when moving to the closed position is much higher than the kinetic energy in an open operation i.e. when moving to the open position, the proposed solution allows for each moving direction definition of a specific damping characteristic. Said damping characteristic can be defined, for example, by dimensioning the piston and/or the guiding tube respectively of an end of the guiding tube, or by means of a gas escape limiting device described below. Further, as the gas damper has an efficiency of 100%, in particular compared to tailor made oil dampers or rubber dampers having a significant lower damping efficiency of ˜50%, with the proposed solution there is no back bouncing which is deadly in case of a make proof switching.

The fast earthing switch is preferably provided as a device designed for interrupting non short-circuit currents only, in particular as a disconnector, more particularly as a high voltage disconnector, or an earthing switch, more particularly as a make-proof earthing switch, or as a medium voltage or high voltage gas-insulated switchgear, GIS, comprising such a device. The term “short-circuit currents”, as opposed to non-short circuit currents, can be understood as currents that are established in the first, transient phase of up to approximately 3 seconds after the point in time, when from a grid operated under high voltage the parts under high voltage get connected to ground. According to this definition, the term “non short-circuit currents” preferably relates to any currents not falling under the definition of “short-circuit currents” given above.

A short circuit is preferably understood as an electrical circuit that allows a current to travel along an unintended path, often where essentially no or a very low electrical impedance is encountered. In general, such short-circuit currents are preferably interrupted within less than 5 seconds after their occurrence and preferably quicker, for example within less than 3 seconds, to prevent damages in electrical networks. Thus, currents that flow from an electrical network, in particular high-voltage network or medium-voltage network, to ground via unintended or intended paths and last longer than 3 seconds or longer than 5 seconds, can be considered as “non short-circuit currents”. This definition of non-short-circuit currents is preferably based on their duration only and is independent of their magnitude or the intendedness or unintendedness of their occurrence. In particular, this definition of non-short-circuit currents may include nominal currents and excludes short-circuit currents of shorter than 5 seconds duration. For example, such non-short-circuit currents can be currents that are induced between two parallel overhead lines, wherein one line is on both sides connected to ground and the other line is delivering current to loads. The non-short-circuit currents induced in the grounded overhead line can be interrupted by the proposed earthing switch.

The arc-quenching medium and/or arc-extinguishing gas may comprise air or at least one air component, in particular selected from the group consisting of: oxygen (O2) and nitrogen (N2), carbon dioxide (CO2), and mixtures thereof. The air or air component may function as a carrier gas or background gas additionally present to an organofluorine compound of the medium or gas. It is particularly preferred that the ratio of the amount of carbon dioxide to the amount of oxygen ranges from 50:50 to 100:1. It is further preferred that the ratio of the amount of carbon dioxide to the amount of oxygen ranges from 80:20 to 95:5, more preferably from 85:15 to 92:8, even more preferably from 87:13 to less than 90:10, and in particular is about 89:11. In this regard, it has been found on the one hand that oxygen being present in a molar fraction of at least 5% allows soot formation to be prevented even after repeated current interruption events with relatively high current arcing. On the other hand, oxygen being present in a molar fraction of at most 20% (i.e. of 20% or less), more particularly of at most 15% (i.e. of 15% or less), reduces the risk of degradation of the material of the device by oxidation. The organofluorine compound can be selected from the group consisting of fluoroethers (including oxiranes), in particular hydro-fluoromonoethers, fluoroketones, in particular perfluoro-ketones, fluoroolefins, in particular hydrofluoroolefins, fluoronitriles, in particular perfluoronitriles, and mixtures thereof. The proposed earthing switch achieves safe operation of the despite of the relatively poor cooling efficiency of the carrier gas.

The arc-quenching medium and/or arc-extinguishing gas can be any suitable gas or medium that enables to adequately extinguish the electric arc formed between the arcing contact members during a current interruption operation, such as, but not limited, to an inert gas as, for example, sulphur hexafluoride SF6. Thereby, the arc between the contact members develops in the arcing region. Specifically, the gas or medium used in the circuit breaker can be SF6 gas or any other dielectric insulation medium or gas, may it be gaseous and/or liquid, and in particular can be a dielectric insulation gas or arc quenching gas. Such dielectric insulation medium or gas can for example encompass media comprising an organofluorine compound, such organofluorine compound being selected from the group consisting of: a fluoroether, an oxirane, a fluoroamine, a fluoroketone, a fluoroolefin, a fluoronitrile, and mixtures and/or decomposition products thereof. Herein, the terms “fluoroether”, “oxirane”, “fluoroamine”, “fluoroketone”, “fluoroolefin” and “fluoronitrile” refer to at least partially fluorinated compounds. In particular, the term “fluoroether” encompasses both hydrofluoroethers and perfluoroethers, the term “oxirane” encompasses both hydrofluorooxiranes and perfluorooxiranes, the term “fluoroamine” encompasses both hydrofluoroamines and perfluoroamines, the term “fluoroketone” encompasses both hydrofluoroketones and perfluoroketones, the term “fluoroolefin” encompasses both hydrofluoroolefins and perfluoroolefins, and the term “fluoronitrile” encompasses both hydrofluoronitriles and perfluoronitriles. It can thereby be preferred that the fluoroether, the oxirane, the fluoroamine and the fluoroketone are fully fluorinated, i.e. perfluorinated.

The arc-quenching medium and/or arc-extinguishing gas can be selected from the group consisting of: a hydrofluoroether, a perfluoroketone, a hydrofluoroolefin, a perfluoronitrile, and mixtures thereof. In particular, the term “fluoroketone” as used in the context of the present inventiondisclosure shall be interpreted broadly and shall encompass both fluoromonoketones and fluorodiketones or generally fluoropolyketones. Explicitly, more than a single carbonyl group flanked by carbon atoms may be present in the molecule. The term shall also encompass both saturated compounds and unsaturated compounds including double and/or triple bonds between carbon atoms. The at least partially fluorinated alkyl chain of the fluoroketones can be linear or branched and can optionally form a ring. The dielectric insulation medium may comprise at least one compound being a fluoromonoketone and/or comprising also heteroatoms incorporated into the carbon backbone of the molecules, such as at least one of: a nitrogen atom, oxygen atom and sulphur atom, replacing one or more carbon atoms. More preferably, the fluoromonoketone, in particular perfluoroketone, can have from 3 to 15 or from 4 to 12 carbon atoms and particularly from 5 to 9 carbon atoms. Most preferably, it may comprise exactly 5 carbon atoms and/or exactly 6 carbon atoms and/or exactly 7 carbon atoms and/or exactly 8 carbon atoms.

Further, the arc-quenching medium and/or arc-extinguishing gas may comprise at least one compound being a fluoroolefin selected from the group consisting of: hydrofluoroolefins (HFO) comprising at least three carbon atoms, hydrofluoroolefins (HFO) comprising exactly three carbon atoms, trans-1,3,3,3-tetrafluoro-1-propene (HFO-1234ze), 2,3,3,3-tetrafluoro-1-propene (HFO-1234yf), and mixtures thereof. The organofluorine compound can also be a fluoronitrile, in particular a perfluoronitrile. In particular, the organofluorine compound can be a fluoronitrile, specifically a perfluoronitrile, containing two carbon atoms, and/or three carbon atoms, and/or four carbon atoms. More particularly, the fluoronitrile can be a perfluoroalkylnitrile, specifically perfluoroacetonitrile, perfluoropropionitrile (C2F5CN) and/or perfluoro-butyronitrile (C3F7CN). Most particularly, the fluoronitrile can be perfluoroisobutyronitrile (according to the formula (CF3)2CFCN) and/or perfluoro-2-methoxypropanenitrile (according to formula CF3CF(OCF3)CN). Of these, perfluoroisobutyronitrile (i.e. 2,3,3,3-tetrafluoro-2-trifluoromethyl propanenitrile alias i-C3F7CN) is particularly preferred due to its low toxicity. The medium or gas can further comprise a background gas or carrier gas different from the organofluorine compound (in particular different from the fluoroether, the oxirane, the fluoroamine, the fluoroketone and the fluoroolefin) and can be selected from the group consisting of: air, N2, O2, CO2, a noble gas, H2; NO2, NO, N2O; fluorocarbons and in particular perfluorocarbons, such as CF4; CF31, SF6; and mixtures thereof. For example, the dielectric insulating gas can be CO2.

The term high voltage means preferably a voltage ranging from 36 to 1,100 kV. A high voltage preferably relates to nominal voltages in the range from above 72 kV to 550 kV, like 145 kV, 245 kV or 420 kV, or even more. Currents of the earthing switch can be in the range from 0.1 kA to 1 kA, even higher such as 80 kA for three seconds. The conductors can be part of a grid for distribution of said high voltage.

The movable contact member may optionally be movable in an axial direction in respect to the guiding tube. The guiding tube is optionally provided as a cylinder, in particular as a gas-tight cylinder, which, however, is fluidly connected to the arcing region via at least one of the channels, particularly the first channel and/or the second channel. The upper end may optionally constitute an upper radially extending base area of the cylinder and/or the lower end may optionally constitute a lower radially extending base area of the cylinder.

An upper end of the movable contact member is optionally, preferably indirectly, coupled to the piston of the arc-blowing mechanism. The piston is optionally provided as one-piece with at least one of the movable contact member, the insulating member, or parts thereof. The movable contact member and/or the piston optionally extends orthogonally through the lower end, in particular through the mid of the lower end.

At least one pressure relief valve of the arc-blowing mechanism is optionally provided in the upper end and/or in the lower end of the guiding tube. The pressure relief valve can be provided as gas escape limiting device thereby allowing creation of a specific damping characteristic.

The piston of the arc-blowing mechanism is optionally provided as a disc-like piston arranged to slide on an inner surface of the guiding tube and having a thereto orthogonal arranged piston rod linearly extending in moving direction within the guiding tube and/or in actuation direction. The disc-like piston optionally extends radially and/or slides gas tight onto the inner surface of the guiding tube. In a section in parallel to the axial and/or actuation direction, the piston may optionally comprise a T-shape. The piston rod optionally extends axially with in the guiding tube.

The piston rod of the arc-blowing mechanism can be formed by means of the insulating member. The insulating member can be, at least a section of, the piston rod of the arc-blowing mechanism. The piston rod can be part separate from the insulating member.

The piston rod is optionally hollow and/or the upper end comprises a damper element facing the hollow piston rod that, when the piston reaches the open position, becomes surrounded by the hollow piston rod. The damper element optionally comprises a cylinder-like shape and/or extends from the upper end towards the lower end. The damper element is optionally dimensioned such that its outer diameter is slightly smaller than an inner diameter of the hollow piston rod.

The piston rod optionally has a channel. For example, when the insulating member forms at least a section of the piston rod, the second channel forms the channel of the piston rod. The channel of the piston rod is optionally in fluid communication to the second channel and/or to the first channel. The channel of the piston rod is thus preferably fluidly connected to the arcing region.

The piston rod is optionally provided as a tube and/or the damper element comprises a tube-like shape preferably having a diameter smaller than a diameter of the piston rod. The diameter is optionally 0,5, 1, 2, 3, 5 or 10 % smaller. The damper element optionally extends from the upper end over 5, 10, 15 or 20 cm into the guiding tube.

The disc-like piston optionally comprises at least one piston bar-like element that optionally extends from the disc-like piston linear in moving direction towards the upper end and/or the lower end and the upper end and/or the lower end comprises a respective piston bar-like opening through which the piston bar-like element passes when the piston reaches the open position and/or the closed position. The piston bar-like element optionally extends in axial direction, preferably over 5, 10, 15 or 20 cm, and/or is provided as rod. An outer diameter of the piston bar-like element is optionally 0,5, 1, 2, 3, 5 or 10 % smaller than an inner diameter of the piston bar-like opening. A plurality of parallel extending piston bar-like elements can be provided. By means of such piston bar-like element the damping characteristic can be individually adjusted.

Optionally the lower end comprises at least one lower bar-like element extending from the lower end linear towards the upper end and/or the disc-like piston optionally comprises a respective lower bar-like opening through which the lower bar-like element passes when the piston reaches the closed position. The lower bar-like element may optionally extend in axial direction, preferably over 5, 10, 15 or 20 cm, and/or is provided as a rod. An outer diameter of the lower bar-like element is optionally 0,5, 1, 2, 3, 5 or 10 % smaller than an inner diameter of the lower bar-like opening. A plurality of parallel extending lower bar-like elements can optionally be provided. By means of such lower bar-like element the damping characteristic can be individually adjusted.

Optionally the lower end is provided disc-like surrounding the piston rod. The lower end is optionally in a gas tight and/or fluid tight manner connected to the guiding tube and/or the piston rod comprises an outer diameter 1, 2, 5 or 10% smaller than an opening of the lower end surrounding the piston rod.

The upper end of the guiding tube may optionally comprise a gas refilling valve. Such gas refilling valve is advantageous for avoiding loss of speed generation if an under pressure takes place. For the closing and opening operation the same spring can be used. In such case the same energy amount is available for both operations. Speed can be controlled by playing with the gas resistance from the piston. In such way the movable contact member can be a bit, but not much, slower in opening than in closing direction.

According to a preferred implementation the contact member and the insulating member may be coupled to each other on respective ends. Especially and preferably for the sake of a definition, a first end is assigned to the movable contact member and a second end is assigned to the insulating member. Typically the contact member and/or the insulating member are/is of an elongated shape along the actuation direction. Preferably the contact member is coupled to the insulating member on one of the two face sides of each of the member. Thus, in their coupled state the contact member and the insulating member typically have an elongated shape with the channels being connected along their direction of elongation. The coupling may be realized by means of screwing one of the members to the other one of the members, e.g. directly (having threads) or indirectly (using screws or the like). The arc-quenching medium can thus be guided through the channels at little aerodynamic loss.

According to another preferred implementation the first end has a first surface and the second end has a second surface. The first surface and the second surface are preferably provided to correspond to each other for the coupling. This means that the surfaces may make a positive fit, for example at least oblique to the and/or in actuation direction, and/or may establish a contact in terms of an area. The contact may be provided in an annular shape, e.g. around the channels The surfaces may be at least sectionally arranged to face each other. This facilitates the fluid communication of the channels at little to no loss of gas, particularly gas pressure, that is guided through the channels.

According to another preferred implementation the first and/or the second surface are/is at least sectionally tapered and/or annular and/or conical. The first surface can be at least sectionally convex or concave. The second surface can be at least sectionally concave or convex. This is beneficial to fluid tightness since such surfaces can easily establish a compression from a coupling and/or may be self-sealing.

It is also preferred that the first surface is sectionally convex and that the second surface is sectionally concave (vice versa is also possible). As such, the movable contact member has the convex surface section that can be contacted by the concave surface section of the insulating member, which results in a good fluid tightness and which is very economic to manufacture in each case: the convex surface of the movable contact member can be machined by turning in an easy setup from an outside in radial direction and/or the concave surface of the insulating member can be machined by forming, particularly plastic forming and/or moulding, particularly injection moulding.

According to another preferred implementation the first end has a first support protrusion and/or the second end has a second support protrusion. The support protrusion(s) may serve as a stop in order to provide a positive fit and/or may serve to provide the first and/or second surfaces to be enlarged to contact each other comprising even better fluid tightness. The support protrusion(s) typically protrude radially, at least in a section, particularly with an annular shape. The support protrusion(s) can be in the shape of a shoulder.

Counter surfaces of the support protrusions can be provided which preferably are tapered, annular and/or arranged to face away from each other. The first support protrusion can thus face away from the second support protrusion. The support protrusion(s) can at least sectionally have a conical, convex and/or concave shape.

According to another preferred implementation a coupling means is provided that is shaped to couple the contact member to the insulating member by means of a positive fit that is effective at least along the actuation direction. For example, the coupling means may comprise or consist of at least one coupling member, such as a bolt, a screw, a clamp, a pipe clamp or the like. In this sense, the coupling means can fasten the first end to the second end, e.g. by bolting it thereto. The coupling means can at least essentially have an annular shape that may grasp the first end and the second end simultaneously for the coupling. The coupling means may be coated, e. g anodized. As such, the inertia can be reduced and/or the coupling element can be provided with little cost to manufacture and/or a rigid and reliable connection can be provided.

According to another preferred implementation the coupling means has at least one coupling element that is circular or semi-circular and designed to surround the contact member and/or the insulating member, particularly one or both of the ends, at least partially. The coupling element may comprise steel and/or aluminum, particularly by more than 50 weight-% or at least substantially consists thereof. The coupling means may have two or more coupling elements of which each can be semi-circular. The coupling elements are more preferably half circular and/or are exactly two, preferably at least essentially similar, coupling elements, e.g. corresponding to each other to form a circle and/or be connected to each other. The coupling element may be coated, e. g anodized. As such, the inertia can be reduced and/or the coupling element can be provided with little cost to manufacture and/or a rigid and reliable connection can be provided.

According to another preferred implementation at least one support surface of the coupling means can be provided that preferably is tapered, annular and/or corresponds to at least one of the support protrusions. Two support surfaces are preferably arranged facing each other and/or are arranged in a V-shape. The coupling means may have an inner groove in a peripheral direction, particularly comprising the V-shape, and/or particularly shaped to surround and/or grasp the first end and the second end simultaneously. This provides a reliable coupling due to a load distribution and/or an inherent positive fit.

According to another preferred implementation at least one conical and/or chamfered and/or angled surface is provided, preferably correspondingly conical/chamfered/angled surfaces are provided. The first surface, the second surface, the at least one support surface, and/or the first and/or the second counter surface, can be chamfered or the like and/or make an angle with the actuation direction in the range between 10 to 80 degrees. The angle preferably is in the range between 30 to 60 degrees and more preferably the angle is in the range between 40 to 50 degrees, in particular 45 degrees. The angle is chosen in order to reduce notch effects that would weaken the coupling and/or its fatigue strength.

The first and/or the second surface can be annular, tapered, chamfered, conical and/or flat in at least one section or in two or more sections. The sections are particularly radially adjacent to each other. Between two adjacent sections a transition may comprise a radius. One section may at least substantially lay in a plane oblique to the actuation direction. One section may thus be closer to the channel(s) than another section, i.e. radially arranged more inwardly. Two adjacent sections may thus form a step or the like that goes up or down in a radial direction. This provides a positive fit in a direction oblique to the actuation direction at good fluid tightness.

Such an embodiment enables a beneficial load distribution and the possibility for a deflection of forces. As such, forces that result from the coupling of the contact member to the insulating member may be redirected in the actuation direction which thus may compress the members against each other so that fluid tightness can be enhanced.

According to another preferred implementation at least one of the channels has an inner diameter in the range between 5 and 100 mm, 5 and 50 mm, and particularly wherein the diameters are at least substantially the same. Said inner diameter may be at least 5 mm, 10 mm, 25 mm or more. Said inner diameter may be up to 100 mm, 75 mm, 50 mm, 40 mm or less. The inner diameter may be a nominal inner diameter, an average inner diameter and/or a minimal inner diameter. The inner diameter may be 25±5 mm or 30±5 mm or 35+5 mm. This is in order to have low aerodynamical resistance at a small size.

According to another preferred implementation at least one of the movable contact member and the insulating part has a wall thickness in the range between 1 and 50 mm, particularly 5 and 40 mm, most preferably between 8 and 32 mm. Said wall thickness may be at least 1 mm, 5 mm, 8 mm or more. Said wall thickness may be up to 50 mm, 40 mm, 32 mm or less. Said wall thickness is preferably homogeneous, e.g. substantially constant in a circumferential and/or axial direction along the respective member or part, preferably at least essentially sectionally. The wall thicknesses may be at least substantially the same. The wall thickness may be a minimum wall thickness, an average wall thickness and/or a nominal wall thickness. The wall thickness may be 5±1 mm. This is in order to have a good compromise of little inertia at sufficient mechanical stability.

According to another preferred implementation the movable contact member comprises a contact part to contact the other contact member and a coupling part coupled to the contact part. The contact part may comprise gold, silver copper and/or tungsten, particularly by more than 50 weight-% or at least substantially consists thereof. The coupling part may comprise steel and/or aluminum, particularly by more than 50 weight-% or at least substantially consists thereof. The contact part and/or the coupling part may be coated, e.g. with gold and/or silver.

The contact part and the coupling part are typically coupled, particularly with a positive fit at least in the actuation direction, for example via a threaded connection, e.g. to be screwed about the actuation direction considered as an axis. Thus, the contact part may comprise a first thread and the coupling part may comprise a further thread corresponding to the first thread. The contact part may have an outer thread and the coupling part may have an inner thread, or vice versa. The parts may as well be coupled to each other by means of plastically deforming and/or crimping the coupling part, the contact part, or both parts, especially in a radial direction in order to achieve a positive fit in the actuation direction. A substance-to-substance bond is possible as well, e.g. gluing, welding, soldering or the like. Such a connection may as well be considered, if applicable, between the insulating member and the moving contact member, especially the coupling part.

It may preferably be that the contact part is one section and the coupling part is another section of the contact member, e.g. formed monolithically, i.e. from or as one piece of material.

According to another preferred implementation the insulating member comprises plastic and/or ceramic, e.g. by more than 50 weight-%, e.g. at least substantially consists of plastic and/or ceramic. The insulating member can be formed as a pipe and/or can be manufactured from extrusion. The insulating member may as well comprise metal which is designed in an insulating manner, for example by means of an insulating coating. The insulating member serves to facilitate designing the path of current flow when using the fast earthing switch in practice.

According to another preferred implementation the arc-blowing mechanism is provided in order to force the arc-quenching medium through the first channel and/or the second channel, particularly the channels, when moving between the open position and the closed position. The arc-blowing mechanism can be formed from aspects of what is described as optional above and/or below and/or shown in the drawings.

The preferably provided operating mechanism can be designed to accelerate the movable contact member when moving between the open position and the closed position. The operating mechanism may comprise an actuating spring for actuating the closing operation of the movable contact member from the open position to the closed position and/or at least one of a driving lever mounted on an operating shaft actuating an opening operation of the movable contact member from the closed position to the open position. The driving lever may optionally partially reload the actuating spring during the opening operation. Further, the operating mechanism may comprise further coupling means operatively coupling the driving lever to the movable contact member and/or the insulating member and/or the coupling part.

The object is further solved by a three-pole high voltage (HV) substation comprising for each pole the fast earthing switch. The substation may particularly comprise, typically for each pole, the operating mechanism and/or a motor for actuating the fast earthing switch of the corresponding pole. In case of such three-pole HV substation, said fast earthing switches can be three-pole operated, in particular comprising a single motor and/or a single operating mechanism, and mechanical connections for actuating all fast earthing switch devices, or single-pole operated, in particular comprising for each pole the motor for actuating the fast earthing switch device of the corresponding pole and/or the operating mechanism.

The object is further solved by a use of the fast earthing switch as described before for interrupting non-short-circuit currents and/or for guiding short circuit currents to ground.

### BRIEF DESCRIPTION OF DRAWINGS

These and other aspects of the disclosure will be apparent from and elucidated with reference to the implementations described hereinafter.

In the drawings:

FIG. 1 shows an upper part of a fast earthing switch for interrupting non-short-circuit currents and/or for guiding short circuit currents to ground in a sectional view,

FIG. 2 shows a contact member and an insulating member of the fast earthing switch of FIG. 1 which are coupled to each other in a perspective view, and

FIG. 3 shows the arrangement of FIG. 2 in a perspective section.

### DESCRIPTION OF IMPLEMENTATIONS

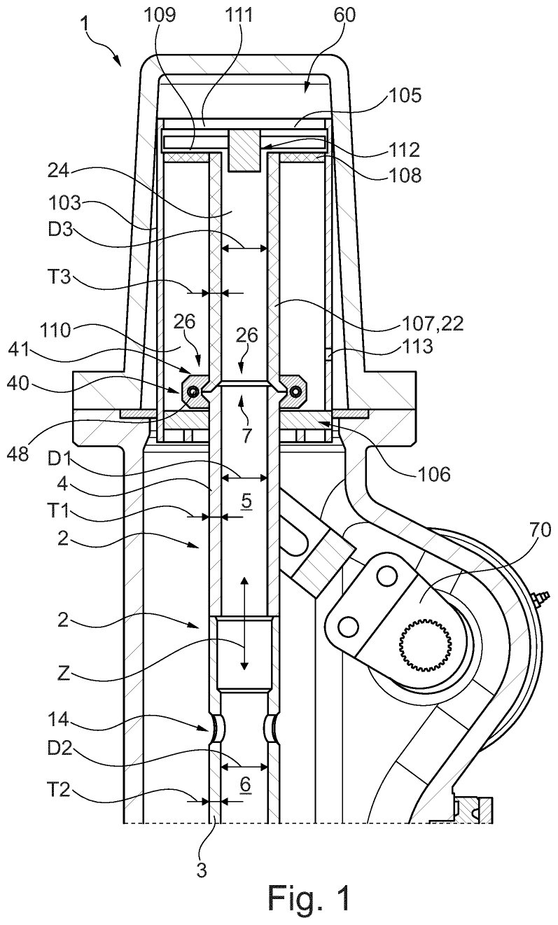

In FIG. 1 a fast earthing switch 1 is shown that is designed for interrupting non-short-circuit currents and that comprises two contact members 2, of which one contact member 2, being a movable contact member 2, is movable along an actuation direction Z and in relation to the other contact member, not shown in the Figs. and arranged beneath/below the moveable contact member 2.

The movable contact member 2 is movable between a closed position, in which the contact members 2 are electrically connected, and an open position, the open position which is shown in FIG. 1, and in which the contact members 2 are electrically unconnected or disconnected.

The movable contact member 2 can be provided as tulip contact member and the other contact member (not shown) can be provided as plug contact member, or otherwise vice versa. The other contact member is typically held fixedly, for example in a housing of the fast earthing switch 1 (not shown).

Also, typically both contact members 2 are arranged movable in respect to each other. The two contact members 2 define an arcing region, not shown in the Figs., in which an arc is generated during a current interrupting operation and in which an arc-quenching medium comprising an arc extinguishing gas is present. The medium/gas is preferably contained in a housing of the fast earthing switch 1.

The contact member 2 has a contact part 3 pointing along the actuation direction Z towards the not shown other contact member and has a coupling part 4. The coupling part 4 serves to couple the contact member 2, particularly the contact part 3, to an insulating member 22. The coupling part 4 is made of steel. The contact part 3 is made of an alloy comprising copper and tungsten, and is preferably coated e.g. with gold. The insulating member 22 is made from plastics and is thus electrically insulating.

The coupling part 4 is arranged between the contact part 3 and the insulating member 22. The insulating member 22 is coupled to the coupling part 4 respective ends 7, 26. Particularly, the end 7 of the contact member 2 at the coupling part 4 is a first end 7 thus assigned to the movable contact member 2. Particularly, the end 26 of the insulating member 22 is a second end 26 assigned to the insulating member 22. The ends 7, 26 are coupled to each other by means of a positive fit that acts along the actuation direction Z and that is realized by means of a coupling means 40 shaped to couple the contact member 2 to the insulating member 22.

The coupling means 40 comprises two coupling elements 41, 42 each of which is semi-circular in the sense of half a circle and surrounds both the contact member 2 and the insulating member 22, particularly their ends 7, 26. The coupling means 40 has at least one coupling member 48, in this case it has two coupling members 48 which are in the form of screws that are screwed oblique to the actuation direction Z through the coupling element 42 into the coupling element 41 to couple the coupling elements 41, 42 together.

The movable contact member 2 has a first channel 5, 6 that at least sectionally extends—in this case fully extends—along the actuation direction Z. Particularly, the contact part 3 partially forms the first channel 5, 6 at the reference 6 and the coupling part 4 partially forms the first channel 5, 6 at the reference 5. At the first end 7 the coupling part 4 is tapered.

The insulating member 22 has a second channel 24 that at least sectionally extends—in this case fully extends—along the actuation direction Z. At the second end 26 the insulating member 22 is sectionally tapered, particularly in a radial section, particularly corresponding to the first end 7.

The channels 5, 6, 24 are in fluid communication in a fluid tight manner in order to direct the arc-quenching medium though the channels 5, 6, 24 at little to no loss of the medium from the channel 5, 6, 24 at the ends 7, 26.

An operating mechanism 70 designed to accelerate the movable contact member 2 is coupled to the contact member 2, especially directly to the coupling part 4. The mechanism 70 has an actuating spring (not shown) and a driving lever that is rotatably coupled to the coupling part 4 (partially shown at the reference mark 70).

Here, the driving lever is made from a metal, wherein however the operating mechanism 70 is isolated relative to the surroundings. There is no path for the current to flow from the coupling part 4 via the operating mechanism 70, especially the driving lever, to a housing or the like. Similarly, the insulating member 22 isolates the coupling part 4 electrically. The described earthing switch 1 can be used in a three-pole high voltage substation thereby comprising for each pole a fast earthing switch 1 and for each pole a motor for actuating the fast earthing switch 1 of the corresponding pole.

The fast earthing switch 1 further comprises a gas-tight cylinder-like guiding tube 103, specifically as right circular hollow cylinder in which a piston 108 that is a disc-like piston having a disc-like head is movable. The piston 8 can slide on an inner surface of the guiding tube 103. The insulating member 22 forms a piston rod 107. An upper end 105 of the insulating member 22 is connected to the piston 108, whereby said piston 108 is slidably arranged for linearly moving in vertical direction (which is the actuation direction Z) between the closed position and the open position within the guiding tube 103. The guiding tube 103 is closed at the upper end 105 and at a thereto opposite lower end 106.

The piston 108 defines a first compression chamber 109 with the upper end 105 and a second compression chamber 110 with the lower end 106. When moving the piston 108 between open position and closed position, arc-quenching medium present in the guiding tube 103 in the first compression chamber 109 respectively in the second compression chamber 110 is compressed, which then leads to a decelerating of the piston 108 when moving into the open position respectively into the closed position.

In order to adjust the damping characteristic of the first compression chamber 109 and the second compression chamber 110, various possibilities exist, which can be combined even if explained separately in the following. As a first measure, a gas escape limiting device formed by a pressure relief valve 111 can be provided, which can be arranged axially extending through the upper end 105 and/or in the lower end 106 of the guiding tube 103.

At least one opening 113 can be provided for gas/medium to flow into or out of the guiding tube 103, e.g. as shown in FIG. 1, preferably on the side of the guiding tube 103. The opening 113 can serve for the chambers 109, 110 to refill with gas and/or to let go negative or positive pressure, particularly to adjust the damping characteristic. The opening 113 may provide a fluid connection of the inside of the guiding tube 103 with the outside around the movable contact member 2 and/or the insulating member 22.

The piston rod 107 and/or the insulating member 22 is provided hollow having a tube-like shape such that the arc-quenching medium can flow from the arcing region into the guiding tube 103. In this respect a damper element 112 in form of a massive cylinder can be arranged on the upper end 105 extending towards the lower end 106 and aligned with the piston rod 107. An outer diameter of the damper element 112 is approx. 10% or less smaller than an inner diameter of the piston rod 107.

Such way the piston rod 107, when reaching the open position, surrounds the damper element 112. This means, that during a movement of the piston 108 into the open position, the arc-quenching medium becomes compressed within the first compression chamber 109 and subsequently tries to escape through the full diameter of hollow piston rod 107. However, when the hollow piston rod 107 surrounds the damper element 112, a free diameter of the system rod 107 becomes much smaller for the arc-quenching medium to escape such that the damping becomes greater at an end of the movement of the piston 107. In a comparable manner a free diameter of the lower end 106 in respect to the outer diameter of the piston rod 107 defines the damper characteristic of the second compression chamber 110 when the piston 108 moves into the closed position.

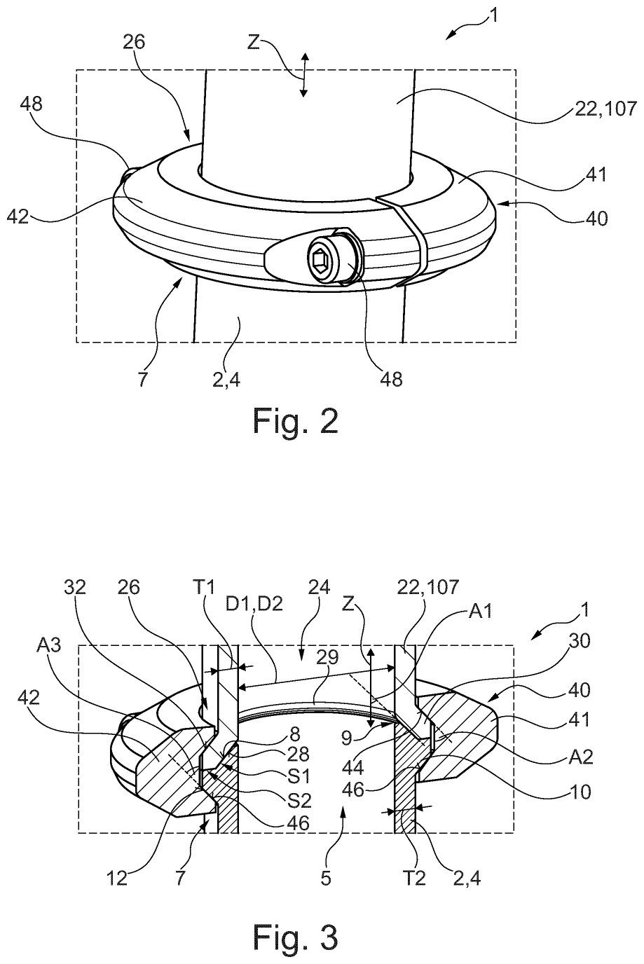

In FIGS. 2 and 3 the connection/coupling between the insulating member 22 and the movable contact member 2 is depicted in more detail.

FIG. 2 depicts the coupling means 40 that couples the contact member 2 to the insulating member 22 by means of a positive fit effective along the actuation direction Z. The two semi-circular coupling elements 41, 42 surround the contact member 2, particularly the coupling part 4, and the insulating member 22

FIG. 3 further depicts in a section through the contact member 2, the insulating member 22 and the coupling means 40 in parallel to the actuation direction Z. It can be seen that the first end 7 has a first surface 8 and the second end 26 has a second surface 28 that correspond to each other for the coupling. The surfaces 8, 28 face each other and are in contact to each other in terms of area, especially in an annular shape.

The first and the second surface 8, 28 are each tapered, chamfered and/or annular in one section S1, and are flat and/or annular in another section S2 that particularly is radially adjacent to the one section S1. The another section S2 lays in a plane oblique to the actuation direction. In this case, which is a preferred configuration, said one sections S1 are arranged closer to the channels 5, 6, 24 than said another sections S2 in order to form a step or the like that goes upwards in radial inward direction at the first surface 8 and downwards in the radial inward direction at the second surface 28. A configuration vice versa, or additional of any of such adjacent sections S1, S2, are disclosed to be preferably adopted (not shown). At the first surface 8 the edge between the sections S1, S2 is sharp (i.e. has no chamfer or radius). At the second surface 28 the edge between the sections S1, S2 has a radius.

The first surface 8 is sectionally concave, i.e. sectionally conically shaped. The second surface 28 is sectionally concave, i.e. sectionally conically shaped, and particularly corresponds to the first surface 8. The conical sections fit together in terms of area and enable a good fluid tightness of the channels 5, 24.

The first surface 8 has a radius at its first edge 9. The second surface 28 has a radius at its second edge 29, smaller, equal to or larger than the radius at the first edge 9. The radii are chosen in the range between 0.5 to 5 mm. The edges 9, 29 are adjacent to each other and form the transition of the surfaces at the channels 5, 24. A low aerodynamical resistance is achieved here.

The first edge 9 and/or the second edge 29 may either be chamfered or at least essentially sharp (i.e. without chamfer or radius), preferably the first and the second edges 9, 29 to be arranged close to each other providing little to no gap (not shown).

The first end 7 has a first support protrusion 10 and the second end 26 has a second support protrusion 30. The support protrusions 10, 30 extend radially and/or are of at least substantially of an annular shape. The support protrusions 10, 30 are preferably monolithically shaped at the first end 7 or the second end 26, respectively.

The first support protrusion 10 has a counter surface 12 that is tapered and annular. The first support protrusion 10 is arranged opposed to the first surface 8 along the actuation direction Z.

The second support protrusion 30 has a counter surface 32 that is tapered and annular. The second support protrusion 30 is arranged opposed to the second surface 28 along the actuation direction Z.

The counter surfaces 12, 32 face away from each other, particularly with respect to the actuation direction Z.

It can be seen in FIG. 3 that the coupling means 40 has support surfaces 44, 46 which are tapered and each correspond to one of the support protrusions 10, 30. The support surfaces 44, 46 are particularly annular when the coupling elements 41, 42 are arranged to have the annular shape as shown, otherwise they are at least partially annular and/or semi-annular. The support surfaces 44, 46 are particularly arranged to grasp the support protrusions 10, 30 from two sides along the actuation direction Z. The support surfaces 44, 46 are arranged in a V-shape since they face each other and encompass a V-shape between each other.

The surfaces 8, 28 are at least partially chamfered and annular. The surfaces 8, 28 both make an angle A1 relative to the actuation direction Z, the angle A1 being 45±2 degrees.

The counter surfaces 12, 32 are chamfered and make an angle A2, A3 relative to the actuation direction Z of 45±2 degrees. The counter surfaces 12, 32 are arranged opposed to each other along the actuation direction Z. The angle A3 at the counter surfaces 12 is equal to and is opposed to the angle A2 at the counter surfaces 32.

The support surfaces 44, 46 are chamfered, and preferably in their combination to couple the contact member 2 and the insulating member 22 the support surfaces 44, 46 can form an annular shape as at least partially shown in the Figures.

The support surface 44 particularly corresponds to the counter surface 32 to achieve a contact in terms of area. The support surface 46 particularly corresponds to the counter surface 12 to achieve a contact in terms of area. Upon fastening the coupling means 40 with its coupling elements 41, 42 and preferably applying a compression to the support surfaces 44, 46 that is oblique to the actuation direction Z, the contact member 2 and the insulating member 22 are coupled and compressed in actuation direction Z as the support surfaces 44, 46 preferably provide an annular force deflection and a positive fit along the actuation direction Z. Thus, the coupling provided by the coupling means 40 provides little to no play and the surfaces 8, 28 are compressed in order to achieve or at least support the fluid communication of the channels 5, 6, 24

The support surfaces 44, 46 both comprise the angle A2, A3 relative to the actuation direction Z. The angle A2 at the support surface 44 is equal to and is opposed to the angle A3 at the support surface 46. For the sake of clarity, the angle A1, A2, A3 is preferably measured as an angle relative to the actuation direction Z that is within the range of up to 180 degrees equal to or lower than 90 degrees. Here, the angles A2 and A3 make up the V-shape of the coupling means 40 that is beneficial to said force deflection and the positive fit.

The channel 5 has an inner diameter D1 of 30±2 mm. The channel 6 has an inner diameter D2 of 30±2 mm. The diameter D1 and the diameter D2 at least essentially correspond to each other. The channel 24 has an inner diameter D3 of 30±2 mm, preferably at least essentially corresponding to the diameter D1 and/or D2.

The movable contact member 2 has at the contact part 3 a wall thickness T1 and/or at the coupling part 4 a wall thickness T2, the wall thickness T1, T2 being 4±1 mm. The wall thickness T1 preferably at least essentially corresponds to the wall thickness T2. The insulating member 22 has a wall thickness T3 of 4±1 mm, preferably at least essentially corresponding to the thickness T1 and/or T2.

The wall thickness T1, T2, T3 is measured radially and/or oblique to the actuation direction Z. The diameter D1, D2, D3 and/or the thickness T1, T2, T3 is/are preferably a nominal value. Particularly, the wall thickness of the contact part 3 and/or the coupling part 4 is reduced sectionally and/or along the actuation direction Z relative to the nominal wall thickness being T1 at 4±1 mm, preferably in the region where the contact part 3 and the coupling part 4 are coupled.

The coupling part 4 has at least one recess 14, here in the form of a radial bore, that brings the channel 6 in a fluid communication radially to its surrounding.

While the invention has been illustrated and described in detail in the drawings and foregoing description, such illustration and description are to be considered illustrative or exemplary and not restrictive; the invention is not limited to the disclosed implementations. Other variations to be disclosed implementations can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 earthing switch
2 contact member
3 contact part
4 coupling part of 2
5 channel of 2
6 channel of 2
7 first end of 2
8 first surface of 2
9 first edge of 2
10 first support protrusion of 2
12 first counter surface of 2
14 recess of 2
22 insulating member
24 channel of 22
26 second end of 22
28 second surface of 22
29 second edge of 22
30 second support protrusion of 22
32 second counter surface of 22
40 coupling means
41 coupling element of 40
42 coupling element of 40
44 upper support surface of 40
46 lower support surface of 40
48 coupling member (screw, etc.) of 40
60 arc-blowing mechanism
70 operating mechanism
103 guiding tube
105 upper end
106 lower end
107 piston rod
108 piston (disc-like piston)
109 first compression chamber
110 second compression chamber
111 pressure relief valve
112 damper element
113 opening
A1 angle
A2 angle
A3 angle
D1 diameter
D2 diameter
D3 diameter
S1 section
S2 section
T1 thickness
T2 thickness
T3 thickness

1. A fast earthing switch comprising:
two contact members of which at least one contact member is movable along an actuation direction in relation to the other contact member between a closed position, in which the contact members are electrically connected, and an open position, in which the contact members are electrically unconnected, said contact members defining an arcing region in which an arc is generated during a current interrupting operation and in which an arc-quenching medium is present; and
an insulating member that is electrically insulating; wherein
the movable contact member comprises a first channel that at least sectionally extends along the actuation direction,
the insulating member comprises a second channel that at least sectionally extends along the actuation direction,
the insulating member and the movable contact member are coupled to each other and
the channels are in fluid communication in order to direct the arc-quenching medium,
comprising:
a coupling means shaped to couple the movable contact member to the insulating member by means of a positive fit that is effective at least along the actuation direction.

2. The fast earthing switch of claim 1, wherein the movable contact member and the insulating member are coupled to each other on respective ends of which a first end is assigned to the movable contact member and a second end is assigned to the insulating member.

3. The fast earthing switch claim 2, wherein the first end has a first surface and the second end has a second surface, wherein the surfaces correspond to each other for the coupling, and particularly wherein the surfaces are at least sectionally arranged to face each other.

4. The fast earthing switch of claim 3, wherein the first and/or the second surface are/is at least sectionally tapered and annular.

5. The fast earthing switch of claim 3, wherein the first and/or the second surface are/is at least sectionally flat and annular, and/or wherein the first surface is at least sectionally convex or concave, and/or wherein the second surface is at least sectionally concave or convex.

6. The fast earthing switch of claim 2, wherein the first end has a first support protrusion and/or the second end has a second support protrusion, and wherein counter surfaces of the support protrusions are provided which are tapered, annular and/or arranged to face away from each other.

7. The fast earthing switch of claim 1, wherein the coupling means has at least one coupling element that is circular or semi-circular and designed to surround the movable contact member and the insulating member, particularly the ends at least partially

8. The fast earthing switch of claim 1, wherein the coupling means has two coupling elements of which each is semi-circular,

9. The fast earthing switch of claim 1, wherein at least one support surface of the coupling means is tapered, annular and/or corresponds to at least one of the support protrusions, and wherein two support surfaces are arranged facing each other and/or in a V-shape.

10. The fast earthing switch of claim 3, wherein
the first and/or the second surface, and/or
the first and/or the second counter surface, and/or
the at least one support surface,
are/is chamfered and/or makes/make at least one angle with the actuation direction in the range between 10 to 80 degrees, preferably the at least one angle being in the range between 30 to 60 degrees and more preferably the at least one angle being in the range between 40 to 50, in particular 45 degrees.

11. The fast earthing switch of claim 1, wherein at least one of the channels has an inner diameter in the range between 5 and 100, in particular 10 and 50 mm, and particularly wherein the diameters are at least substantially the same, and/or wherein at least one of the movable contact member and the insulating member has a preferably homogeneous wall thickness in the range between 1 and 50 mm, particularly between 8 and 32 mm.

12. The fast earthing switch of claim 1, wherein the movable contact member comprises a contact part to contact the other contact member and a coupling part coupled to the contact part, wherein the contact part comprises copper and/or tungsten, by more than 50 weight-% or at least substantially consists thereof, and/or wherein the coupling part comprises steel and/or aluminum, by more than 50 weight-% or at least substantially consists thereof.

13. The fast earthing switch of claim 1, wherein the insulating member comprises plastic and/or ceramic, and by more than 50 weight-% or at least substantially consists thereof.

14. The fast earthing switch of claim 1, comprising an arc-blowing mechanism in order to force the arc-quenching medium through the first channel and/or the second channel when moving between the open position and the closed position, and/or an operating mechanism designed to accelerate said movable contact member when moving between the open position and the closed position, particularly the arc-blowing mechanism being mechanically coupled to the insulating member.

15. A three-pole high voltage substation comprising for each pole a fast earthing switch according to claim 1, and for each pole an operating mechanism and/or a motor for actuating the fast earthing switch of the corresponding pole.
